(19) United States
(12) Patent Application Publication
(10) Pub. No.: US 2009/0163064 A1
(43) Pub. Date: Jun. 25, 2009

(54) ELECTRICAL CONNECTOR

(75) Inventors: Eugene P. Janulis, Austin, TX (US); David V. Mahoney, Austin, TX (US); Garry L. Sjolander, Pflugerville, TX (US); Richard D. Twigg, Leander, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/961,260

(22) Filed: Dec. 20, 2007

(51) Int. Cl. H01R 13/52; H01R 33/00

(52) U.S. Cl. 439/271; 439/702

(57) ABSTRACT

An electrical connector includes an electrically insulative cylindrical housing, an electrically conductive member retained within the cylindrical housing, and at least one biasing member biased toward a surface of the conductive member. The conductive member defines a longitudinal axis and the biasing member(s) is/are circumferentially disposed about the longitudinal axis of the conductive member. Conductors inserted into the cylindrical housing are urged into electrical contact with the conductive member by the biasing member(s).

### BACKGROUND

Electric cables are broadly employed in a variety of industries and applications, including applications in communications, telecommunications, automotive, and/or appliances. Some electrical cables distribute power across vast power grids or networks, moving electricity from power generation plants to the consumers of electrical power, and moving electricity from one power grid to another power grid. Other electrical cables are employed in wiring homes and/or businesses.

Electrical cables generally include a conductive core (typically copper or aluminum) and may include one or more layers of surrounding insulating material. Some power cables include multiple twisted conductive wires. Electrical cables are constructed to carry high voltages (greater than about 50,000 volts), medium voltages (between about 1,000 volts and about 50,000 volts), or low voltages (less than about a 1,000 volts).

It is sometimes desirable to periodically form a splice or a junction in the cable, for example to electrically connect two electrical devices or to distribute electricity to additional branches of a power grid. Such branches may be further distributed until the grid reaches individual homes, businesses, offices. As one example, a single power cable supplying electrical power to a group of several buildings is commonly branched to each of the buildings. As used in this specification, the terms “splice” and “junction” are used interchangeably, and in each case refer to the portion of an electrical system where an incoming cable is connected to at least one outgoing cable.

Connecting incoming cables with one or more outgoing cables can potentially result in heating the cables at the junction, or heating the electrical connector employed to form the junction. It is desirable to quickly and conveniently form the splice in a manner that is configured to minimize electrical heating of the cables.

For these and other reasons, there is a need for the present invention.

### SUMMARY

One aspect provides an electrical connector including an electrically insulative cylindrical housing, an electrically conductive member retained within the cylindrical housing, and at least one biasing member biased toward a surface of the conductive member. The conductive member defines a longitudinal axis and the biasing member(s) is/are circumferentially disposed about the longitudinal axis of the conductive member. Conductors inserted into the cylindrical housing are urged into electrical contact with the conductive member by the biasing member(s).

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is an exploded perspective view of an electrical connector according to one embodiment.

FIG. 2 is a perspective view of the electrical connector shown in FIG. 1 as assembled.

FIG. 3A is a cross-sectional view of the electrical connector shown in FIG. 2.

FIG. 3B is a cross-sectional view of the electrical connector shown in FIG. 2 and including an inserted conductor.

FIG. 3C is a cross-sectional view of another electrical connector including means for removing inserted conductor shown in FIG. 3B.

FIG. 4A is a perspective view of a biasing member of the electrical connector shown in FIG. 1 according to one embodiment.

FIG. 4B is a perspective view of a bell-shaped biasing member according to another embodiment.

FIG. 5 is a perspective view of a biasing member according to another embodiment.

FIG. 6 is a perspective view of a biasing member according to another embodiment.

FIG. 7 is a perspective view of a biasing member including teeth according to another embodiment.

FIG. 8 is a cross-sectional view of an electrical connector including a passageway configured to receive a pass-through ground conductor according to one embodiment.

FIG. 9 is a cross-sectional view of an electrical connector according to another embodiment.

FIG. 10 is a perspective view of the electrical connector shown in FIG. 2 including a boot configured to seal over a cap of the electrical connector according to one embodiment.

FIG. 11A is a perspective view of an electrical connector according to another embodiment.

FIG. 11B is an end view of the electrical connector shown in FIG. 11A.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

Embodiments provide an electrical connector having at least one biasing member that is configured to urge a conductor into electrical contact with a conductive member of the electrical connector. In one embodiment, the electrical connector includes an electrically insulative cylindrical housing disposed about an electrically conductive member, and at least one biasing member is circumferentially disposed within the conductive member and configured to urge an electrical conductor inserted into the housing into electrical contact with the conductive member.

The housing and the conductive member are configured to provide improved heat dissipation and minimize undesirable overheating of conductors inserted into the electrical connector.

Embodiments provide an electrical splice connector configured to electrically connect conductors/wires having a wide range of conductor sizes. In one embodiment, an electrical splice connector is provided that electrically connects conductors, such as wires in a residential dwelling, having a size ranging from 10 gauge solid to 18 gauge stranded wire. Other embodiments provide an electrical splice connector suited for electrically connecting telecom, automotive, or industrial-sized conductors.

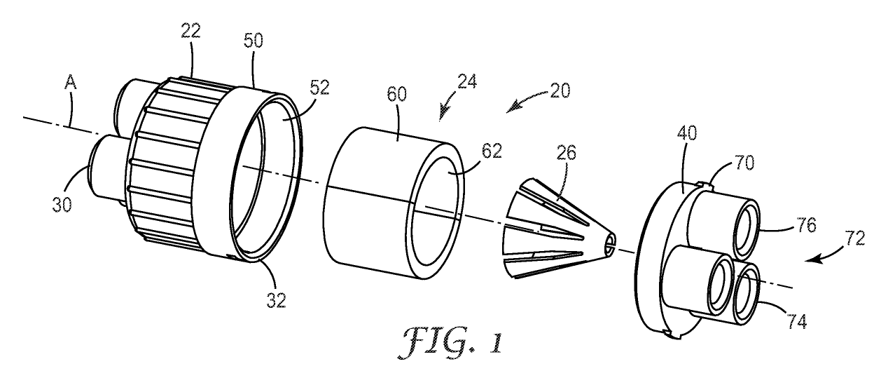

FIG. 1 is an exploded perspective view of an electrical connector 20 according to one embodiment. Electrical connector 20 includes a housing 22, a conductive member 24 retained within housing 22, and at least one biasing member 26 circumferentially disposed within the conductive member 24. Biasing member 26 is configured to urge a conductor inserted into housing 22 into electrical contact with conductive member 24.

In one embodiment, housing 22 is an electrically insulative cylindrical housing including a closed end 30 opposite an open end 32, and conductive member 24 is a substantially cylindrical electrically conductive member retained within housing 22 by a cap 40 that is attachable to open end 32 of housing 22. In one embodiment, open end 32 of housing 22 is configured to receive cap 40, and cap 40 may be press-fit, snap-fit, glued, welded, threaded or otherwise suitably coupled to open end 32 of housing 22. In one embodiment, closed end 30 of housing 22 provides a “dead end” along interior surface (e.g., a stop) against which inserted conductors “bottom out” when inserted into housing 22 through cap 40.

In one embodiment, housing 22 defines an exterior surface 50 opposite an interior surface 52, where interior surface 52 is sized to enable conductive member 24 to be inserted into housing 22. In one embodiment, housing 22 provides a substantially cylindrical housing, open end 32 is substantially circular, and cap 40 includes a substantially circular perimeter configured to couple with open end 32.

In this specification, the term “cylindrical” means any body defined by a longitudinal axis and a wall that defines an exterior surface, and includes circular cylinders, non-circular cylinders, solid cylinders, and hollow cylinders. The peripheral shape of a cross-section of the wall thus includes circular shapes, non-circular shapes, polygonal shapes, and other geometric shapes. Thus, a cylindrical housing or member is not limited to housings or members having circular shapes in cross-section, and includes polygonal shapes that approximate a cylinder.

Suitable material for forming housing 22 includes plastic such as thermoplastic, thermoset, curable plastics, molded plastics, and other suitable electrical non-conductive materials including electrically non-conductive non-plastic materials. In one embodiment, housing 22 is formed of a transparent or translucent polycarbonate. Other suitable materials for forming housing 22 are also acceptable. In another embodiment, housing 22 is configured to provide high rates of heat transfer, which can be useful when connecting high voltage conductors. Suitable high heat transfer housings 22 include housings formed of a plastic filled with thermally conductive fillers or filler materials, or housings formed of a composition of a metal filled with plastic particles or other suitable fillers.

In one embodiment, conductive member 24 defines a longitudinal axis A and includes a substantially cylindrical member disposed within housing 22. In one embodiment, conductive member 24 defines an exterior surface 60 and an interior surface 62. When assembled, exterior surface 60 is contiguous with interior surface of housing 22. In one embodiment, conductive member 24 is press-fit within cylindrical housing 22 and is retained in place by cap 40.

Suitable materials for conductive member 24 include electrically conductive materials in general, including metals such as copper, alloys of copper, aluminum, alloys of aluminum, bronze, nickel, alloys of nickel, or other suitable electrically conducting materials. In one embodiment, conductive member 24 is a substantially cylindrical member formed of brass including a tin plating.

In one embodiment, biasing member 26 is a conical spring that is biased toward interior surface 62 of conductive member 24. In another embodiment, biasing member 26 is a wedge or wedge-shaped device configured to bias toward interior surface 62 of conductive member 24. Biasing member 26 is selected to have a “spring constant” that is configured to non-removably retain an inserted conductor between biasing member 26 and interior surface 62 of conductive member 24. In one embodiment, biasing member 26 is an electrically conducting conical spring formed of metal. In other embodiments, biasing member 26 is not an electrical conductor and is not formed of metal.

In this specification, the term “conical” includes cones, polygonal shapes that approximate a cone, multi-sided members that approximate a funnel-shape, members that approximate a bell-shape, and similar such shapes that are truncated by removing an apex of a conical shape, resulting in a frustum having a plane defined by the removed apex that is approximately parallel to a base of the conical shape.

In general, biasing member 26 is configured to provide a biasing force radially outward in the direction of interior surface 62 of conductive member 24. In one embodiment, the inserted conductor has a size of between about 10-20 gauge and the biasing force of biasing member 26 is configured to enable easy insertion of the conductor into housing 22 and provide a sufficient biasing force (i.e., spring force) selected to hold the conductor in electrical contact with conductive member 24. In one embodiment, biasing force for biasing member 26 is configured to provide a sufficiently high force such that an inserted conductor cannot be removed from housing 22 without a pull force of about 15 pounds or destructively breaking one or both of electrical connector 20 or the conductor.

Suitable materials for fabricating biasing member 26 include metals and other electrically conductive material. In one embodiment, biasing member 26 is formed from spring steel, stainless steel, bronze, or copper into a substantially conical spring. In one embodiment, biasing member 26 is formed of heat treatable steel, such as 410 stainless steel, although other metals, metal-coated plastics, or plastics are also acceptable depending upon the end-use application. Biasing member 26 is suitably fabricated by die cutting, stamping, drawing, annealing, and/or punching.

In one embodiment, cap 40 includes a flange 70 configured to snap-fit or twist-fit into open end 32 of housing 22 and includes a plurality of openings 72 configured to extend into housing 22. In one embodiment, only one opening 72 is provided that is configured to receive two conductors, each conductor biased into electrical contact with conductive member 24 by biasing member 26. In another embodiment, plurality 72 of openings includes at least two openings such as three openings or four openings or more Each opening, such as opening 74 or opening 76, is configured to receive an electrical conductor. Cap 40 is generally formed of electrically non-conductive material and is configured to couple to open end 32 of housing 22. In one embodiment, cap 40 is molded from plastic and is configured to be removably attached to open end 32 of housing 22.

In one embodiment, a kit of parts is provided that includes electrical splice connector 20 and a plurality of caps 40, where the plurality of caps 40 includes at least two end caps each defining at least one conductor receiver opening and at least one end cap 40 defining at least two conductor receiver openings. The user can then select the end caps having the desired number of receiver openings for that particular installation application.

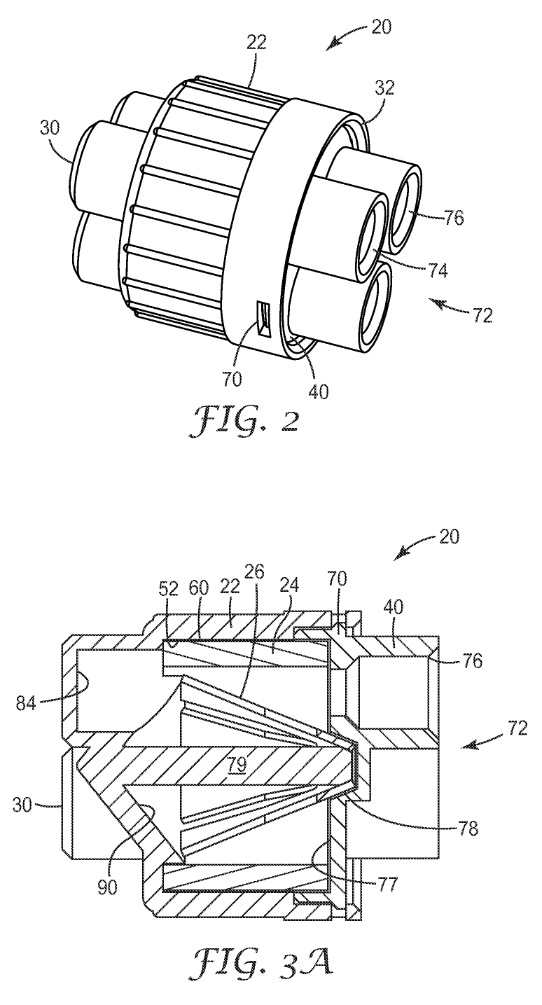

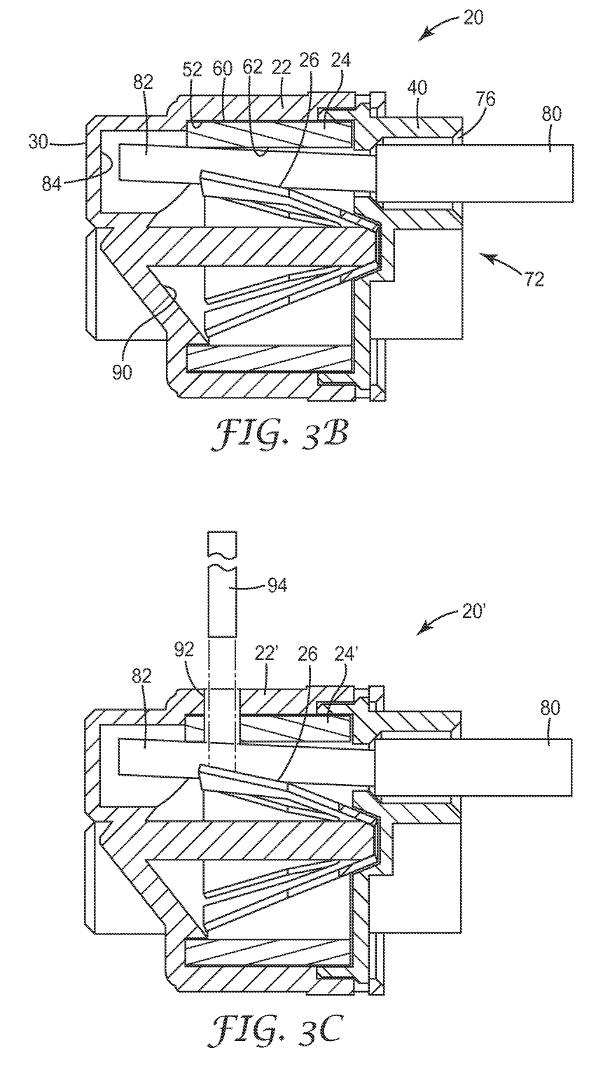

FIG. 2 is a perspective view of electrical connector 20 as assembled. Cap 40 is retained within open end 32 and flange 70 is snap-fit into a slot provided on housing 22. Plurality of openings 72 including openings 74 and 76 are configured to receive an inserted electrical conductor 80 (FIG. 3B). Electrical connection is established by biasing member 26 (FIG. 1) forcing electrical conductor 80 into electrical contact with conductive member 24 (FIG. 1). Electrical connector 20 is lightweight and durable. Conductive member 24 (FIG. 1) is disposed adjacent to interior surface 52 (FIG. 1) of housing 22 such that electrical connector 20 efficiently radiates heat generated by the inserted conductors. In one embodiment, conductive member 24 is contiguous with housing 22 and configures electrical connector 20 for improved heat transfer. For example, in one embodiment housing 22 and conductive member 24 combine to effectively dissipate the heat generated by the electrically connected conductors inserted into housing 22.

FIG. 3A is a cross-sectional view of the electrical connector shown in FIG. 2. Flange 70 of cap 40 is engaged with housing 22. In one embodiment, interior surface 77 of cap 40 defines a relief bore 78 that is sized to receive an end of biasing member 26. In one embodiment, an interior surface 84 of closed end 30 defines a post 79 extending into housing 22 along a central axis of housing 22. One end of biasing member 26 nests within relief bore 78 and is retained in place by post 79. In the case where biasing member 26 is a conical spring, relief bore 78 is sized to receive the small-diameter end of biasing member 26.

In one embodiment, interior surface 84 of closed end 30 is sloped along wall 90 to accommodate radial movement of biasing member 26 toward post 79.

FIG. 3B is a cross-sectional view of the assembled electrical connector 20 including inserted electrical conductor 80. Conductor 80 includes a conductive end portion 82, which includes in one embodiment stripping electrical insulation off of conductor 80 to expose conductive end portion 82. Conductor 80 has been inserted into opening 76 and conductive end portion 82 is adjacent to interior surface 84 of closed end 30. Biasing member 26 urges conductive portion 82 of conductor 80 into electrical contact with interior surface 62 of conductive member 24. Other conductors are insertable into plurality of openings 72 and are likewise urged by biasing member 26 against conductive member 24 to establish electrical connection between the inserted conductors. In one embodiment, at least closed end 30 is transparent to enable viewing of the electrical connection between conductive end portion 82 and conductive member 24.

FIG. 3C is a cross-sectional view of an electrical connector 20′ including means for removing inserted conductor 80. In one embodiment, housing 22′ and conductive member 24′ each define a slot 92 that combine to provide a passageway for a tool 94 to enter connector 20′. Tool 94 is configured to deflect biasing member 26, thus relieving the biasing stress applied by biasing member 26 toward conductive member 24′, to enable removal of conductor 80. For example, embodiments provide slot 92 sized to receive a flat-blade screwdriver or similar device that may be employed to displace biasing member 26 a distance sufficient to relieve the force that the biasing member 26 applies to conductor 80. In other embodiments, a passageway is provided in cap 40 (FIG. 1) to enable tool 94 to enter housing 22′ parallel to inserted conductor 80 and relieve the biasing stress applied by biasing member 26 toward conductive member 24′.

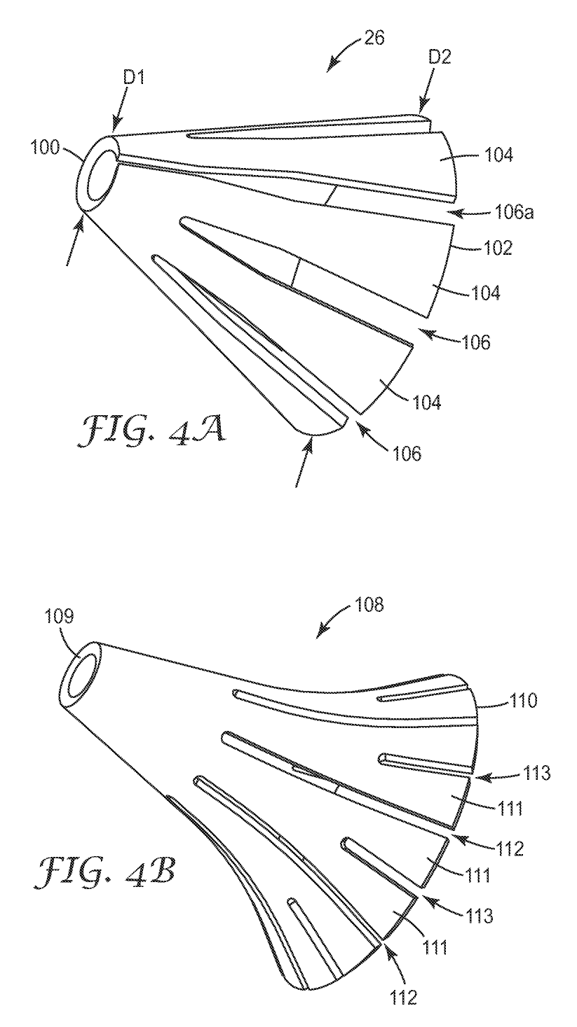

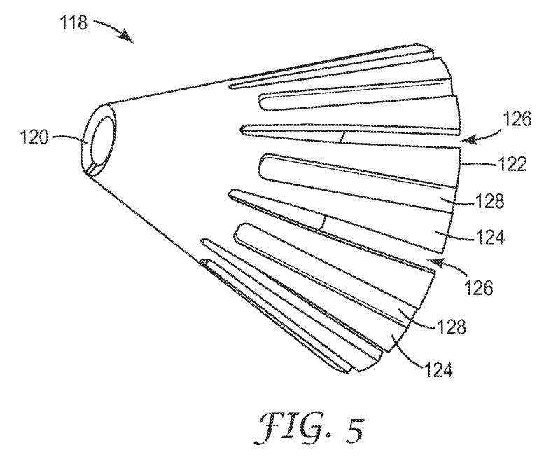

FIG. 4A is a perspective view of conical biasing member 26. In one embodiment, biasing member 26 is funnel-shaped and includes a first end 100 that defines a first diameter D1 and a second end 102 that defines a second diameter D2 that is larger than first diameter D1. In one embodiment, biasing member 26 provides a conical spring having a plurality of segmented leafs 104 defined by relief slots 106 that extend from second end 102 toward first end 100. Leafs 104 are flexible and are configured to bias in a radial direction such that biasing member 26 has attributes of a living spring. In one embodiment, one relief slot 106a extends an entire length between first end 100 and second end 102 to configure conical leaf spring 26 to flexibly accommodate a wide range of conductor sizes.

FIG. 4B is a perspective view of another form of a conical biasing member 108 according to one embodiment. In one embodiment, biasing member 108 is bell-shaped and includes a first end 109 that defines a first diameter and a second end 110 that defines a second diameter that is larger than first diameter. In one embodiment, biasing member 108 provides a conical spring having a plurality of segmented leafs 111 defined by relief slots 112 that extend from second end 110 toward first end 100. In one embodiment, leafs 111 include openings 113 configured to adjust a biasing force applied by leafs 111.

FIG. 5 is a perspective view of a biasing member 118 or a conical spring member 118 according to another embodiment. Spring member 118 includes a first end 120 and a second end 122, where second end 122 has a diameter that is larger than first end 120 such that spring member 118 is funnel-shaped. Spring member 118 includes segmented leafs 124 defined by relief slots 126 that extend from second end 122 toward first end 120.

With additional reference to FIG. 3B, in one embodiment leafs 124 include a channel 128 formed between two relief slots 126. Channel 128 is configured to receive conductive end portion 82 of conductor 80. In one embodiment, channel 128 is configured to enable spring member 118 to guide/support smaller diameter (18-20 gauge) conductors, and in particular smaller diameter twisted wire conductors, enabling the smaller diameter conductors to be inserted into electrical connector 20 as described herein without undesirable buckling of the conductor.

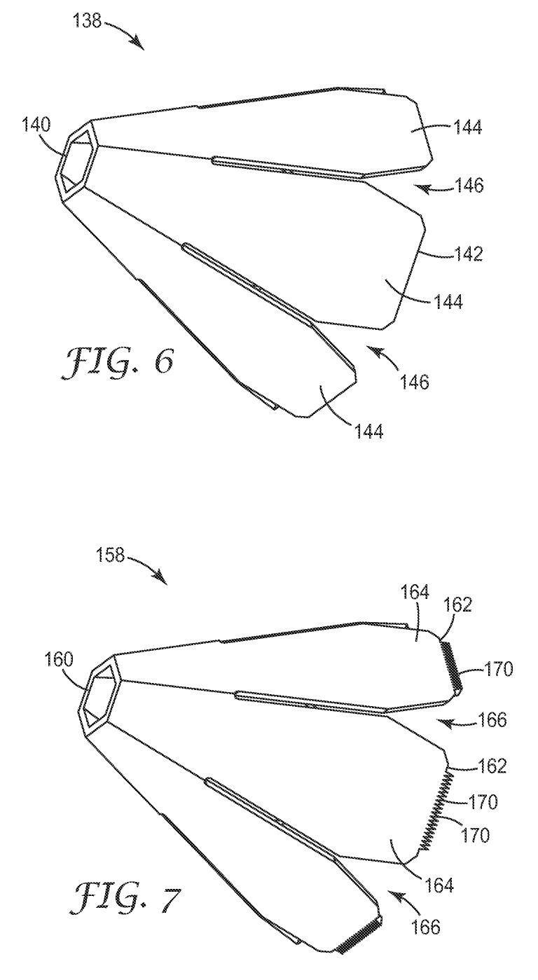

FIG. 6 is a perspective view of a biasing member 138 or a conical spring member 138 according to another embodiment. Spring member 138 includes a first end 140 and a second end 142 opposite first end 140. Spring member 138 defines a conical spring member having a diameter at second end 142 that is larger than a diameter at first end 140. In one embodiment, spring member 138 includes a plurality of leafs 144 defined by relief slots 146 that extend from second end 142 toward first end 140. In one embodiment, leafs 144 are polygonal in shape and are connected one to another along first end 140 such that conical spring member 138 is non-circular in cross-section at first end 140 and second end 142.

FIG. 7 is a perspective view of a biasing member 158 or a conical spring member 158 according to another embodiment. Spring member 158 includes a first end 160, a second end 162, and leafs 164 defined by relief slots 166 that extend from second end 162 toward first end 160. In one embodiment, leafs 164 include teeth 170 formed at second end 162. With additional reference to FIG. 3B, teeth 170 are configured to engage with conductive end portion 82 of conductor 80 to securely retain conductor 80 within electrical connector 20. In one embodiment, teeth 170 are configured to remove, scratch through, or uncover oxidation formed on conductive end portion 82 to ensure electrical connection with conductive end portion 82.

With reference to FIG. 1, biasing member 26 includes any one of biasing/spring members 108, 118, 138, or 158 described herein.

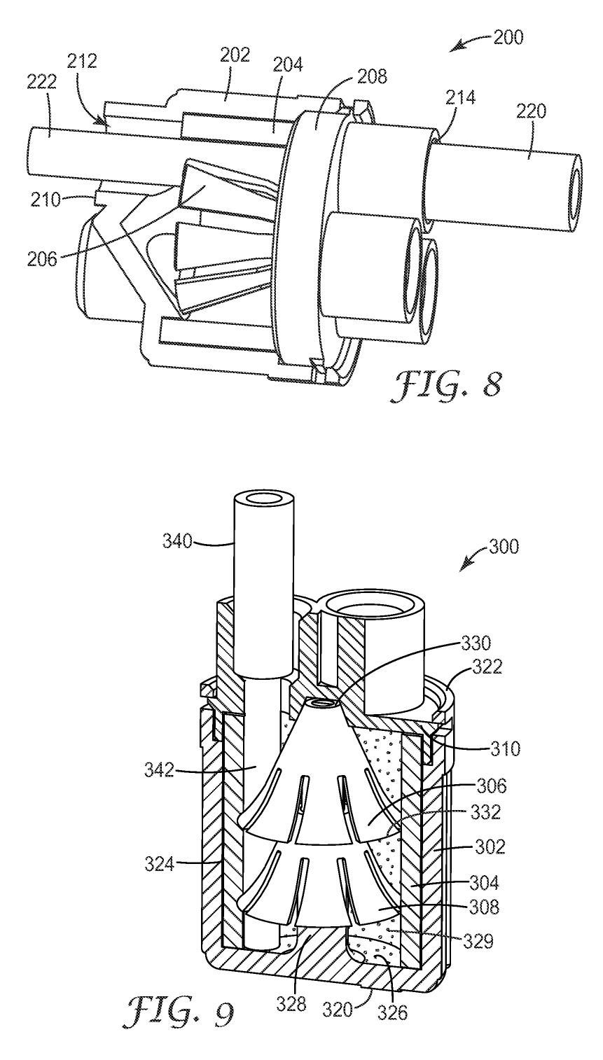

FIG. 8 is a cross-sectional view of an electrical connector 200 according to another embodiment. Electrical connector 200 includes an electrically insulative cylindrical housing 202, an electrically conductive member 204 retained within housing 202, and a spring 206 circumferentially disposed within conductive member 204 and retained within housing 202 by a cap 208.

In one embodiment, housing 202 includes an end 210 that defines a passageway 212 that is aligned with an opening 214 defined by cap 208. In one embodiment, electrical connector 200 provides a pass-through ground assembly in which an inserted conductor 220 is inserted into housing 202 through opening 214 and exits housing 202 through passageway 212. In this manner, a conducting portion 222 of conductor 220 passes through electrical connector 200 and is configured to be connected to a switch or otherwise terminated. In one embodiment, electrical connector 200 provides passageway 212 that enables conductive portion 222 to pass through housing 202 and provide a junction connector for all ground wires. It is to be understood that some conductors 220, such as ground wire, do not include an insulative covering.

FIG. 9 is a cross-sectional view of an electrical connector 300 according to another embodiment. Electrical connector 300 includes an electrically insulated cylindrical housing 302, an electrically conductive member 304 retained within housing 302, a first spring 306 and a second spring 308 retained within conductive member 304 by a cap 310.

In one embodiment, housing 302 includes a closed end 320 opposite an open end 322, an internal housing surface 324 extending between closed end 320 and open end 322, an interior base surface 326 defined by closed end 320, and a post 328 extending from interior base surface 326 substantially parallel to inner housing surface 324. In one embodiment, first spring 306 and second spring 308 are stacked within conductive member 304 and coupled to post 328.

In one embodiment, an interior volume of conductive member 304 optionally includes sealant 329. Sealant 329 is configured prevent the ingress of moisture, dust, insects, or other debris into electrical splice connector 300. In one embodiment, sealant 329 is selected and configured to minimize or eliminate oxidation of metal portions of conductive member 304, springs 306, 308 and conductors/wires inserted into electrical splice connector 300. In one embodiment, sealant 329 is selected and configured to minimize or eliminate the ingress of moisture or debris to portions of conductive member 304, springs 306, 308 and conductors/wires inserted into electrical splice connector 300.

In one embodiment, sealant 329 is a hydrophobic sealant, examples of which includes gel sealants or grease sealants. In general, gel sealant 329 includes soft rubbers and gels having shape memory. Gel sealant 329 is typically formed from at least one polymer in combination with at least one oil. The oil provides an extender for the gel sealant and includes hydrocarbon oil, such as naphthinic oils, paraffinic oils, aromatic oils, silicone oil, or vegetable ester oil, or a plasticizer such as phthalate ester oils. In one embodiment, gel sealant 329 includes multiple extenders and polymers, including extenders and polymers intermediate between oil and polymer. In one embodiment, gel sealant 329 includes a liquid rubber that is not part of the gel forming polymer network, such as polybutene of moderate molecular weight or a low molecular weight ethylene propylene rubber (EPR). These materials, in combination, are configured to tailor characteristics of the gel sealant 329 by increasing tack, for example.

The polymer-based gel can be either a thermoplastic or cured in place. The curing includes thermal curing, room temperature vulcanization, ultraviolet curing, e-beam curing, or other radiation initiated curing. It is desirable that the polymer be compatible with oil, and can include a rubber-like morphology, having flexible chains with molecular flexibility between cross-linking sites. Suitable polymers include polyurethanes, polyesters, polyepoxys, polyacrylates, polyolefins, polysiloxanes, polybutadienes (including polyisoprenes), hydrogenated polybutadienes and polyisoprenes, or block copolymers. The blocks of the block copolymers may include the above-identified polymers, and/or poly(monoalkenylarenes) including polystyrene. Suitable block copolymers include styrene-ethylene-butylene-styrene (SEBS), styrene-ethylene-propylene-styrene (SEPS), styrene-rubber-styrene polymers, di-block polymers, tri-block polymers, graft and star-block copolymers, or block copolymers with blocks that are non-homogeneous. Other suitable materials include closed-cell foamed materials, and materials incorporating micro-bubbles or soft (or hard) fillers.

Sealant 329 includes grease sealants. A grease is defined to be viscoelastic hydrophobic composition including 50-95% hydrocarbon oil, such as naphthinic oils or paraffinic oils and/or blends, aromatic oils, silicone oils, vegetable oils, or plasticizer oils such as phthalates. Greases are hydrophobic liquids at room temperature and include a low volatility such that they do not experience appreciable loss of mass after a long duration exposure to high operating temperatures. Some grease includes agents to provide the mechanical properties of low shear yield point and higher adhesion than cohesion. Desirable additives to grease include inorganic materials, including molybdenum sulfide, silica gels (including silica gels including a surface treatment control agglomeration) lithium compounds, soaps, waxes including polyethylene and polypropylene waxes, polymers including polyurethanes, polyesters, polyepoxys, polyacrylates, polyolefins, polysiloxanes, polybutadienes (including polyisoprenes), hydrogenated polybutadienes and polyisoprenes, or block copolymers. The blocks of the block copolymers may include the above identified polymers and poly(monoalkenylarenes) including polystyrene. Suitable block copolymers include SEB, SEP, SEBS, SEPS, Styrene-rubber polymers, di-block polymers, graft and star-block copolymers, or block copolymers with blocks that are non-homogeneous. In one embodiment, grease sealant 329 includes a grease sealant prepared from shearing a gel, as is disclosed in U.S. Pat. Nos. 5,292,058, 5,286,516, 5,418,001 or 5,601,668.

In a manner similar to FIG. 1 above, when electrical connector 300 is assembled, springs 306, 308 are retained between ends 320, 322 of housing 302. For example, the springs 306, 308 are stacked or nested relative to each other such that the smaller diameter of each spring 306, 308 is oriented nearer to cap 310 and the larger diameter of each spring 306, 308 is disposed nearer to closed end 320 of housing 302. In other words, the smaller diameter of spring 306 is adjacent to cap 310, the smaller diameter of spring 308 is nested within spring 306, and the larger diameter of spring 308 is adjacent to closed end 320.

With reference to FIG. 1, housing 302 is similar to housing 22, conductive member 304 is similar to conductive member 24, springs 306, 308 are similar to biasing member 26, and cap 310 is similar to cap 40. In one embodiment, two or more springs 306, 308 are provided within conductive member 304 to ensure that a sufficient biasing force is directed against an inserted conductor 340 to cause electrical connection between conductive end portion 342 of conductor 340 and conductive member 304. In one embodiment, springs 306, 308 combine to provide an outward biasing force that restricts or negates removal of conductor 340 after it is inserted into electrical connector 300.

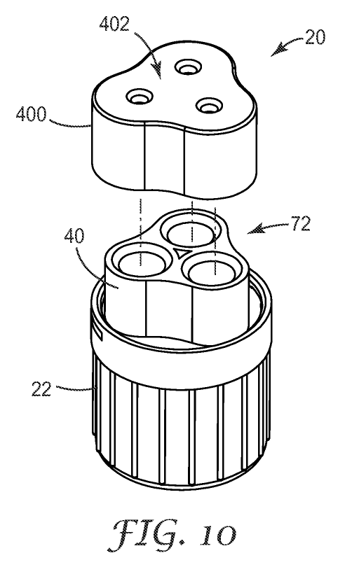

FIG. 10 is a perspective view of the electrical connector 20 shown in FIG. 2 including an optional boot 400 configured to seal cap 40 according to one embodiment. In one embodiment, boot 400 is formed of a flexible, elastic polymer such as a thermoplastic elastomer and defines a plurality of openings 402. Plurality of openings 402 are configured to provide selective access to each of the plurality of openings 72 formed in cap 40. In one embodiment, boot 400 is configured to seal electrical connector 20 against the ingress of moisture and debris into housing 22. In another embodiment, boot 400 is configured to seal against conductors (not shown) inserted into openings 402.

In one embodiment, boot 400 is configured to constrain and/or retain sealant (329 in FIG. 9) provided on an interior (e.g., within) boot 400. For example, in one embodiment no sealant is provided within housing 22, but sealant (not shown) is provided under boot 400. Boot 400 is provided to constrain sealant, provide additional sealant to connector 20, or provide an entirety of sealant for connector 20. In one embodiment, when an inserted conductor is removed from housing 22, opening 402 is configured to skive or remove the sealant from the conductor.

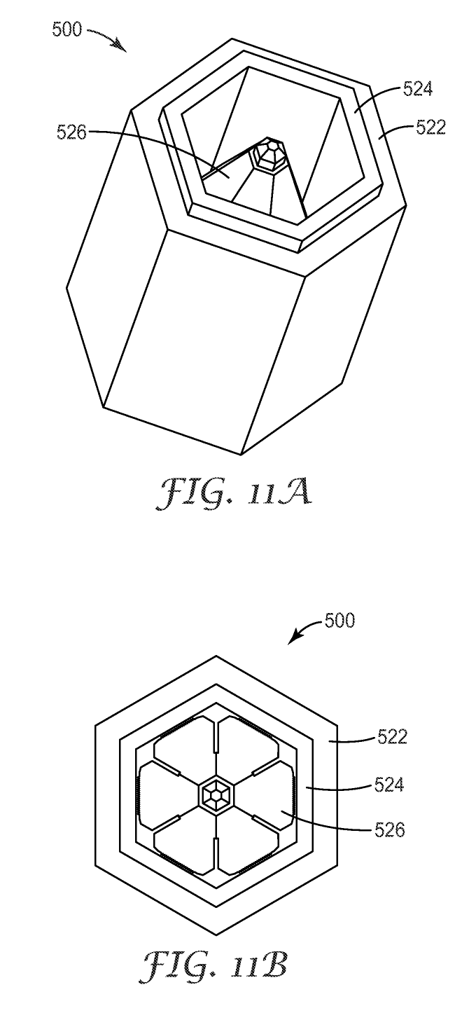

FIG. 11A is a perspective view of a multi-sided cylindrical electrical connector 500 according to another embodiment and FIG. 11B is an end view of electrical connector 500. Electrical connector 500 includes a housing 522, a conductive member 524 retained within housing 522, and at least one biasing member 526 circumferentially disposed within the conductive member 524. Biasing member 526 is configured to urge a conductor inserted into housing 522 into electrical contact with conductive member 524.

In one embodiment, housing 522 provides an electrically insulative cylindrical housing having a plurality of sides and conductive member 524 provides a cylindrical conductive member 524 having a plurality of sides retained within the cylindrical housing 522. In one embodiment, one biasing member 526 is retained within cylindrical conductive member 524, although multiple stacked biasing members could be disposed within housing 522 as described above in FIG. 9. Although not required, in one embodiment biasing member 526 includes a plurality of sides selected to correspond with the number of sides of cylindrical conductive member 524. Other geometrical shapes of cylindrical housing 522, cylindrical conductive member 524, and conical biasing member 526 are also acceptable.

Housing 522 is suitably formed of the materials described above for housing 22, conductive member 524 is suitably formed of the materials described above for conductive member 24, and biasing member 526 includes the biasing members described above in FIGS. 4A-7.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments of an electrical connector as discussed herein. Therefore, it is intended that this invention be limited only by the claims and the equivalents thereof.

1. An electrical connector comprising:
an electrically insulative cylindrical housing;
an essentially cylindrical electrically conductive member retained within the cylindrical housing, the conductive member defining a longitudinal axis; and
at least one conical biasing member disposed within the conductive member and circumferentially about the longitudinal axis of the conductive member and biased toward an inner surface of the conductive member;
wherein conductors inserted into the cylindrical housing are urged into electrical contact with the conductive member by the at least one conical biasing member.

2. The electrical connector of claim 1, wherein the electrically insulative cylindrical housing comprises a plastic material filled with thermally conductive material.

3. The electrical connector of claim 1, wherein the electrically insulative cylindrical housing comprises a closed end opposite an open end, the at least one conical biasing member disposed within the conductive member between the closed end and the open end of the housing.

4. The electrical connector of claim 3, wherein the at least one conical biasing member comprises opposing ends, a first opposing end disposed contiguous with the closed end of the housing.

5. The electrical connector of claim 4, wherein the closed end of the housing defines a post extending from an interior surface of the closed end along the longitudinal axis, a second of the opposing ends of the at least one conical biasing member coupled to an end portion of the post.

6. (canceled)

7. The electrical connector of claim 1, wherein the at least one conical spring comprises a first conical spring and a second conical spring nested relative to the first conical spring, each conical spring circumferentially disposed about the longitudinal axis of the conductive member.

8. The electrical connector of claim 7, wherein the first and second conical springs each comprise a first end that defines a first diameter and a second end that defines a second diameter that is larger than the first diameter, each respective second end nearer to the closed end of the housing than the first end.

9. The electrical connector of claim 3, further comprising:
a cap attachable to the open end of the housing, the cap defining a plurality of openings configured to extend into the cylindrical housing, each opening configured to receive a respective one of the conductors inserted into the cylindrical housing.

10. The electrical connector of claim 9, wherein the cap defines a relief bore configured to receive one end of the conical biasing member.

11. The electrical connector of claim 9, wherein the closed end of the cylindrical housing defines at least one passage configured to enable one of the conductors inserted into one of the plurality of openings of the cap to pass through an entire length of the cylindrical housing.

12. The electrical connector of claim 9, further comprising:
a flexible boot configured to seal the cap, the boot configured to provide selective access to each of the plurality of openings formed in the cap.

13. The electrical connector of claim 9, wherein at least one of the housing and the cap is optically transparent.

14. The electrical connector of claim 1, further comprising:
a sealant disposed within the electrically insulative cylindrical housing, the sealant configured to minimize oxidation on and ingress of moisture to the conductors inserted into the cylindrical housing.

15. The electrical connector of claim 1, further comprising:
means for biasing the at least one conical biasing member away from a surface of the conductive member to enable removal of the conductors inserted into the cylindrical housing.

16. The electrical connector of claim 15, wherein the electrically insulative cylindrical housing and the electrically conductive member retained within the cylindrical housing each define a passageway communicating with the at least one conical biasing member, the passageway sized to receive a tool configured to deflect the at least one conical biasing member.

17. An electrical connector comprising:
a cylindrical housing;
a substantially cylindrical electrically conductive insert disposed within the housing;
at least one conical biasing member separate from and disposed within the electrically conductive insert; and
a cap coupled to an end of the housing and defining a plurality of openings accessing the electrically conductive insert, each opening configured to receive an inserted wire conductor;
wherein the at least one conical biasing member forces the inserted wire conductor into electrical contact with an interior surface of the electrically conductive insert.

18. The electrical connector of claim 17, wherein the housing comprises a substantially cylindrical housing defining an inner housing surface and a substantially circular open end, and the cap comprises a substantially circular perimeter coupled to the open end.

19. The electrical connector of claim 18, wherein the electrically conductive insert is nested within the housing contiguous with the inner housing surface.

20. The electrical connector of claim 18, wherein the housing defines an internal housing length and the electrically conductive insert extends substantially along an entirety of the internal housing length.

21. The electrical connector of claim 17, wherein the at least one biasing member comprises at least one conical spring axially aligned on a central axis of the substantially cylindrical electrically conductive insert.

22. The electrical connector of claim 21, wherein the at least one conical spring comprises a first conical spring and a second conical spring, the first and second conical springs each axially aligned on the central axis of the substantially cylindrical electrically conductive insert.

23. The electrical connector of claim 22, wherein the housing comprises a closed butt end defining a central post extending into the housing substantially parallel to the inner housing surface, the first and second conical springs coupled to the post.

24. The electrical connector of claim 23, wherein the closed butt end comprises a passageway configured to enable the inserted conductors to enter an opening in the cap, pass though the cylindrical housing, and exit the cylindrical housing though the passageway.

25. The electrical connector of claim 21, wherein the at least one conical spring comprises a first end that defines a first diameter and a second end that defines a second diameter that is larger than the first diameter, the first end adjacent to the cap.

26. The electrical connector of claim 25, wherein the at least one conical spring defines at least two relief slots extending from the second end toward the first end.

27. The electrical connector of claim 26, wherein the at least one conical spring defines a channel between the at least two relief slots, the channel configured to receive the inserted conductor.

28. The electrical connector of claim 25, wherein the second end of the conical spring comprises a plurality of retaining teeth.

29. The electrical connector of claim 17, wherein the at least one conical biasing member comprises a polygonal biasing member axially aligned on a central axis of the cylindrical housing.

30. The electrical connector of claim 29, wherein the polygonal conical biasing member comprises a first end disposed adjacent to the cap, a second end, and a plurality of walls each angled to extend from the first end to the second end to define a funnel-shape.
